(19) United States
(12) Patent Application Publication
(10) Pub. No.: US 2015/0313419 A1
(43) Pub. Date: Nov. 5, 2015

(54) DISPENSING CONTAINER

(71) Applicant: FRESHORIZE USA LLC, Winter Springs, FL (US)

(72) Inventor: Abdul Ebrahim Patel, Woodford Green (GB)

(21) Appl. No.: 14/703,096

(22) Filed: May 4, 2015

Related U.S. Application Data
(60) Provisional application No. 61/987,713, filed on May 2, 2014.

(51) Int. Cl. A47K 5/12; B05B 15/06

(52) U.S. Cl. CPC A47K 5/1211; B05B 15/061

(57) ABSTRACT

A dispensing container including a housing for containing a fluid, said housing comprising an upper housing portion and a lower housing portion, said upper housing portion for delivering the fluid from the container, a projection member, having a circumferential surface, extending from the lower housing portion, wherein said projection member fits within a mount such that the housing can be secured in a generally vertical configuration extending upward from the mount when positioned there within, and a material disposed on said projection member to minimize movement of the housing when secured is disclosed. Another dispensing container to be received within a mount having a mount opening for receiving the dispensing container and a dispensing system are also disclosed.

### CROSS-REFERENCE TO RELATED APPLICATIONS

This application claims the benefit of U.S. Provisional Application No. 61/987,713 filed May 2, 2014, and incorporated herein by reference in its entirety,

### BACKGROUND

Fluid dispensers, in particular, liquid soap dispensers for use in lavatories must typically be securely mounted so as to prevent spillage of the liquid soap contained within the dispensers. These dispensers are particularly useful in moving transportation lavatories, such as in airplanes, trains and other transport vehicles where the dispensers need to be secured in the lavatory for use, while also being easily removable for refilling of the liquid soap and replacement of the container, in some embodiments.

### SUMMARY

Embodiments of a dispensing container for mounting within a lavatory mount are provided herein. The dispensing container comprises a housing tier containing a fluid, said housing comprising an upper housing portion and a lower housing portion, said upper housing portion for delivering the fluid from the container. The dispensing container also comprises a projection member, having a circumferential surface, extending from the lower housing portion, wherein said projection member fits within a mount such that the housing can be secured in a generally vertical configuration extending upward from the mount when positioned there within. The dispensing container also comprises a material disposed on said projection member to minimize movement of the housing when secured.

In another embodiment, the dispensing container is to be received within a mount having a mount opening for receiving the dispensing container. The dispensing container comprises a housing for containing a fluid, said housing comprising an upper housing portion and a lower housing portion, said upper housing portion for delivering the fluid from the container. The dispensing container further comprises a projection member extending from the lower housing portion, wherein said projection member comprises a recessed portion within at least a portion of a circumferential surface of the projection member, and at least one flattened portion on the circumferential surface, the at least one flattened portion of the projection member associated with at least one flattened portion of an inner surface of the mount opening to substantially prevent rotation of the container relative to the mount. The dispensing container also comprises at least one groove within a portion of the circumferential surface of the projection member, wherein the at least one groove comprises a first end and a second end, wherein said first and second ends terminate at the at least one flattened portion of the projection member, and wherein the projection member is removably engageable within the mount opening.

In another non-limiting embodiment, the dispensing system comprises a housing for containing a fluid, the housing comprising an upper housing portion and a lower housing portion, the upper housing portion for delivering the fluid from the container. Also included is a projection member extending from the lower housing portion, wherein the projection member comprises a recessed portion within at least a portion of the circumferential surface of the projection member. A material disposed on said projection member, wherein the material comprises a slip resistant material to minimize movement is also disclosed. The dispensing system also comprises a mount comprising an outer surface, an inner surface, and a mount opening, said mount opening having a shape and dimension to receive the projection member such that the housing can be secured in a generally vertical configuration extending upward from the mount, and the material is disposed between the projection member and the inner surface of the mount to prevent rotational movement of the housing.

### BRIEF DESCRIPTION OF THE DRAWINGS

A more particular description briefly stated above will be rendered by reference to specific embodiments thereof that are illustrated in the appended drawings. Understanding that these drawings depict only typical embodiments and are not therefore to be considered to be limiting of its scope, the embodiments will be described and explained with additional specificity and detail through the use of the accompanying drawings in which:

FIG. 1 shows a perspective view of an embodiment of a dispensing container;

FIG. 2 shows an upside perspective view of an embodiment of the dispensing container;

FIG. 3 shows an upside perspective view of another embodiment of the dispensing container;

FIG. 4 shows a perspective view of an embodiment of a ring member used with an embodiment of the dispensing container;

FIGS. 5A and 5B show an embodiment of the dispensing container being inserted into a mount;

FIG. 6 shows an embodiment of an adaptor for use with an embodiment of the dispensing container;

FIG. 7 shows a perspective view of the adaptor;

FIG. 8 shows a perspective view of a lower portion of the container with the adaptor;

FIGS. 9A and 9B show an embodiment of the adaptor placed onto an embodiment of the dispensing container; and

FIG. 10 shows a perspective view of a system embodiment

### DETAILED DESCRIPTION

It has been identified herein that substantially preventing rotation of fluid dispensers when mounted in a lavatory is beneficial. Furthermore, providing a liquid soap dispenser that can be used with a number of current existing lavatory mounts is particularly beneficial.

For the purposes of promoting an understanding of the principles and operation of the embodiments disclosed herein, reference will now be made to the embodiments illustrated in the drawings and specific language will be used to describe the same. It will nevertheless be understood that no limitation of the scope of the embodiments is thereby intended, such alterations and further modifications in the illustrated device, and such further applications of the principles of the embodiment as illustrated therein being contemplated as would normally occur to those skilled in the art to which the embodiment pertains.

The terminology used herein is for the purpose of describing particular embodiments only and is not intended to be limiting. As used herein, the singular forms “a,” “an,” and “the” are intended to include the plural forms as well, unless the context clearly indicates otherwise these terms do not denote a limitation of quantity, but rather denote the presence of at least one of the referenced item. Furthermore, to the extent that the terms “including,” “includes,” “having,” “has,” “with,” or variants thereof are used in either the detailed description and/or the claims, such terms are intended to be inclusive in a manner similar to the term “comprising.” Moreover, unless specifically stated, any use of the terms first, second, etc., does not denote any order, quantity or importance, but rather the terms first, second, etc., are used to distinguish one element from another.

The term “container” as used herein may include, but is not limited to, any bottle or other vessel that may dispense amounts of a fluid or a semi-fluid, such as, but not limited to, soaps, shampoos, lotions, mouthwashes, aftershaves, creams or pastes.

The term “fluid” as used herein may include, but is not limited to, any fluid known to those skilled in the art, including liquid, gas, and other such fluids. In one non-limiting embodiment, fluid may refer to a liquid, and in one particular embodiment, the liquid may include a liquid soap.

The term “mount” as used herein may include, but is not limited to, any structure capable of attachment to a surface, such as, but not limited to, countertops, walls, floors, shelves, various surfaces in bathrooms or other mounts.

The term “projection” as used herein may include, but is not limited to, a securing means extending from or into either a container or a mount.

The term “generally vertical” configuration comprises an angle formed between a longitudinal axis of the housing and a longitudinal axis of a generally horizontal surface transverse to the housing, wherein at least a portion of the housing is received within a mount, wherein said mount is provided on the horizontal surface, in one non-limiting embodiment, wherein between approximately a 90 degree angle and approximately a 45 degree angle is formed between the longitudinal axis of the housing and the longitudinal axis of the horizontal surface, in one non-limiting embodiment.

The term “minimize movement” as used herein includes a decrease, a reduction, or an elimination of movement in whole or in part.

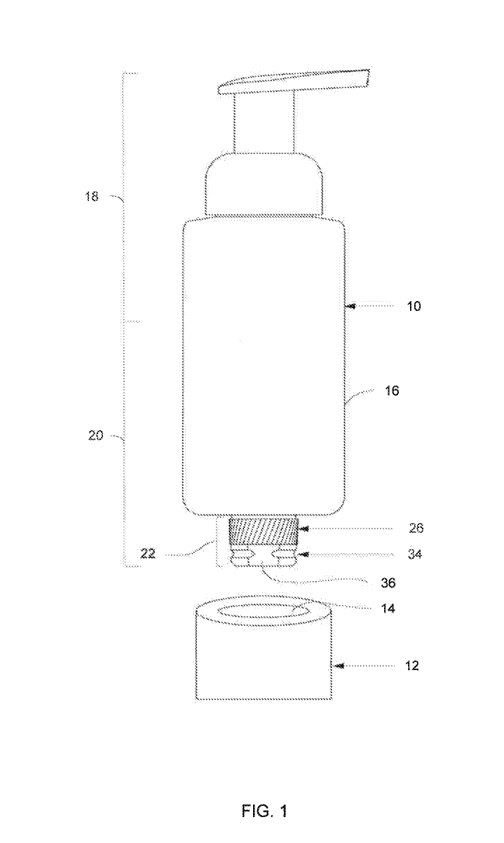

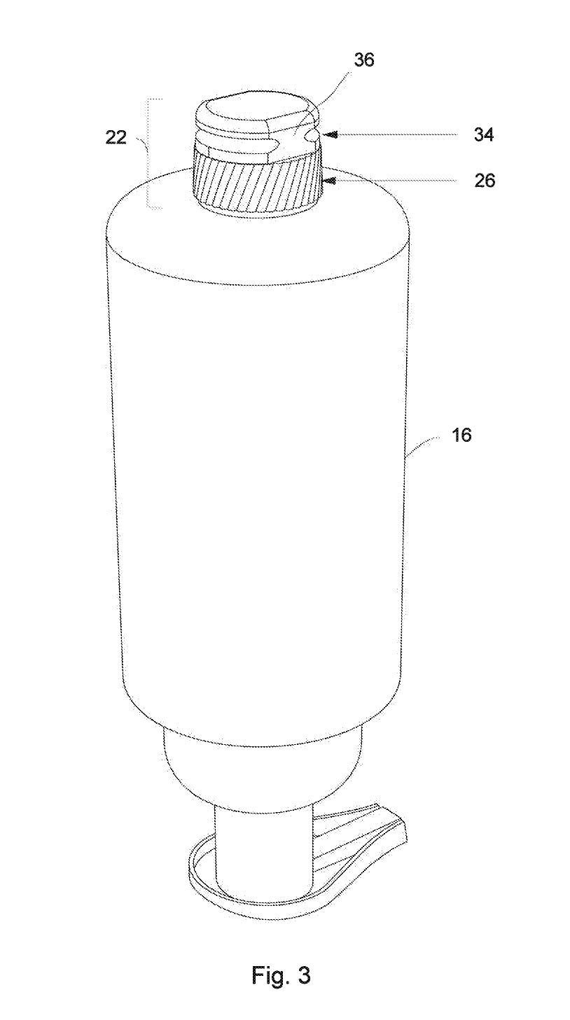

Embodiments herein include, as illustrated in FIGS. 1-3, a dispensing container 10 configured or adapted to be received within a mount 12 in a lavatory, in one non-limiting example. The mount may include an opening 14, wherein the opening 14 of the mount 12 is configured in such a way so as to receive at least a portion of the dispensing container 10. In an embodiment, the dispensing container 10 may include a housing 16 for containing a fluid, such as a liquid soap in a non-limiting example. The housing 16 of the dispensing container 10 may include an upper housing portion 18 for delivering the liquid soap to a user of the dispensing container 10 and a lower housing portion 20 for associating with the mount 12. The lower housing portion 20 may include a projection member 22 configured to interact with the mount 12 of the lavatory to place the container 10 within the lavatory for use.

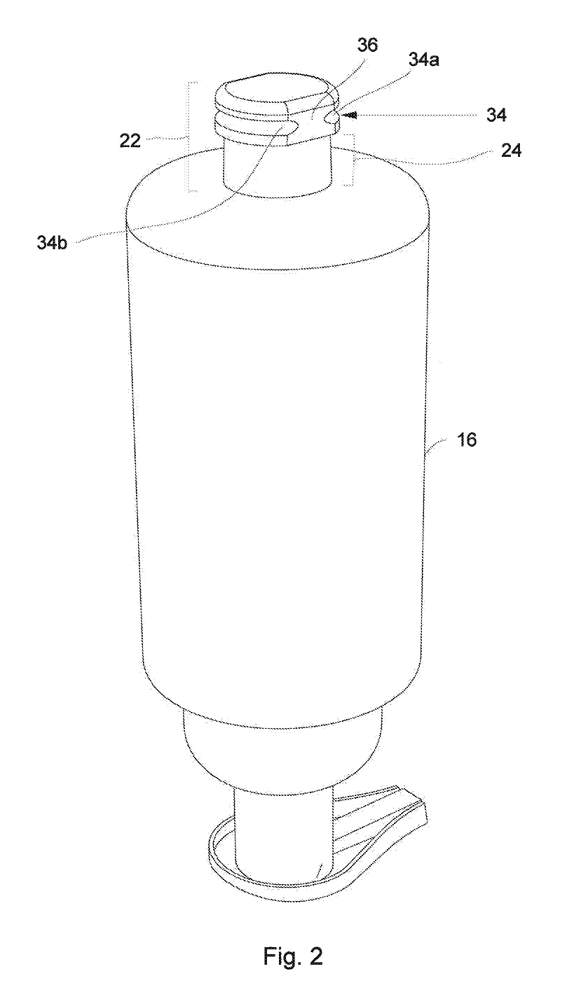

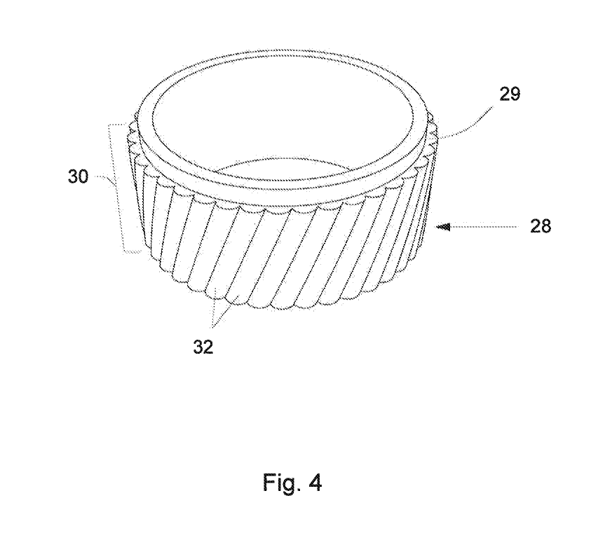

The projection member 22 of the container 10 may include a cylindrically shaped member, in one non-limiting embodiment, having at least one recessed portion 24 (recessed portion shown in FIG. 2). The projection member 22 may be configured to fit within the mounting opening 14 and is further configured to accept a material 26. With material 26, the projection member 22 is still configured to fit within the mounting opening 14. The material 26 may encircle the projection member 22, or at least a portion thereof, at the recessed portion 24. The material 26 may include a rubber or other similar material as known to those of skill in the art, in non-limiting embodiments. In an embodiment, the material 26 includes a slip-resistant material. In another non-limiting embodiment, the material 26 may be formed as a ring member 28 (as shown in FIG. 4), configured to surround the at least one recessed portion 24 of the projection member 22 of the container 10. In an alternative embodiment, the projection member 22 may not include a recessed portion 24, and the material 26 may be disposed around at least a portion of the projection member 22 or may be integrated into the projection member 22 or the recessed portion 24. For example, in one non-limiting embodiment, the projection member 22 may be formed of a non-slip material.

As further illustrated in FIGS. 1-3, the projection member 22 may further include at least one groove 34 formed around at least a portion of the circumference of the projection member 22. The at least one groove 34 may be provided to interact with a protrusion of the mount 12 that projects inward toward the mount opening 14 in a non-limiting embodiment, so as to further secure the container 10 within the mount 12. Such protrusions of the mount may be provided in a previously installed mount which was designed for another dispenser. Thus, embodiments disclosed herein are provided to replace the prior art dispenser that was provided specific the prior art mount.

Though not required, the projection member 22 may further include, in a non-limiting embodiment, at least one flatted portion 36 of its outer circumference as shown in FIGS. 1-3. The mount opening 14 may also include at least one flattened portion (not shown), in one non-limiting embodiment, wherein the at least one flattened portion of the projection member 36 may be configured to interact with at least one flattened portion of the mount opening, such that once the projection member 22 is placed within the mount opening 14, rotation of the projection member 22 relative to the mount 12 is prevented or substantially limited. The projection member 22 may include multiple flattened portions 36 or other structural features which are provided to interact with corresponding flattened portions or structural features within the mount opening 14 so as to substantially prevent rotation of the projection member 22 within the opening 14 of the mount 12, when the projection member 22 is placed there within, in other non-limiting embodiments.

The at least one groove 34 of the projection member 22 mentioned above may include a first end 34a and a second end 34b (shown in FIG. 2), wherein the first and second ends 34a, 34b of the at least one groove 34 may terminate at the at least one flattened portion 36 of the projection member 22, in one non-limiting embodiment. A person of ordinary skill in the art would understand that multiple grooves may be provided in or on the projection member 22, for example, so as to interact with protrusion(s) of the mount 12 to provide a secure placement of the container 10 on the mount 12 while preventing or reducing rotation of the container relative to the mount. Furthermore, the groove(s) 34 of the projection member 22 may extend circumferentially around the entire projection member 22, or may only extend around a portion of the projection member 22 as shown in the Figures herein.

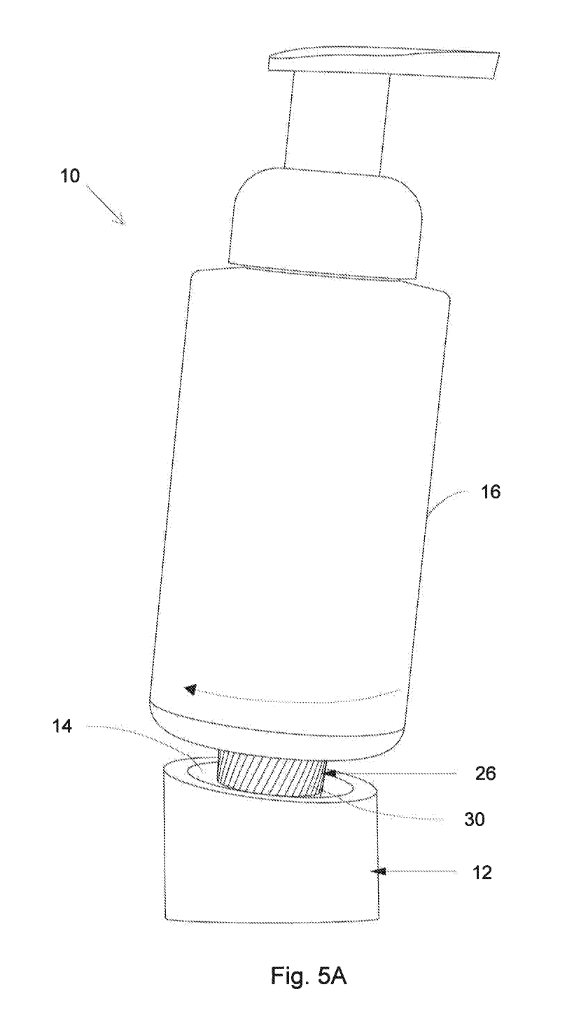

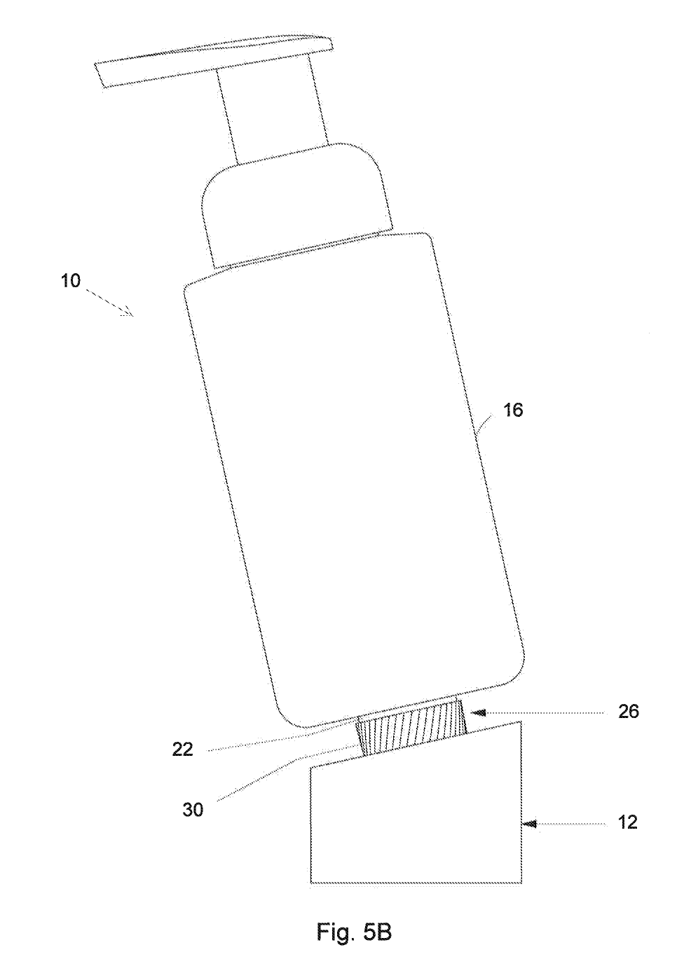

In a further embodiment, a ring member 28 may be provided as shown in the perspective view of FIG. 4, and may include a ring member recessed portion 29 to allow for easibility in placing the ring member 28 onto the projection member 22. The ring member 28 (or in other embodiments the material 26 disposed around the projection member 22) may include a ribbed portion 30 on its outer surface, wherein the ribbed portion 30 of the ring member 28 may minimize movement between the ring member 28 and the mount 12 when the projection member 22 is placed within the mount opening 14. The ribbed portion 30 of the ring member 28 or the material 26 may include a series of ribs 32, which may include a series of diagonally oriented ribs as shown in the embodiment of FIG. 4, disposed around the outer circumference of the ring member 28 as shown in FIG. 4. The diagonal ribs 32 may be oriented substantially parallel to one another, in a non-limiting embodiment, as illustrated in FIG. 4, so as to allow the projection member 22 to be inserted into an opening 14 of the mount 12 with a rotating motion as demonstrated in FIGS. 5A-5B. Various other patterns and textures for the outer surface of the ring member 28 or the material 26 known to those of ordinary skill in the art are contemplated herein.

FIGS. 5A-5B illustrate the insertion of the container 10 having a projection member 22 extending from housing 16, wherein the projection member 22 includes ribbed portion 30. FIGS. 5A-B show the rotational insertion of the projection member 22 into the opening 14 of the mount 12, demonstrating rotation of the container 10 while pressing the projection member 22 into the opening 14 so as to insert the projection member 22 into the mount opening 14 to secure the container 10 within the mount 12.

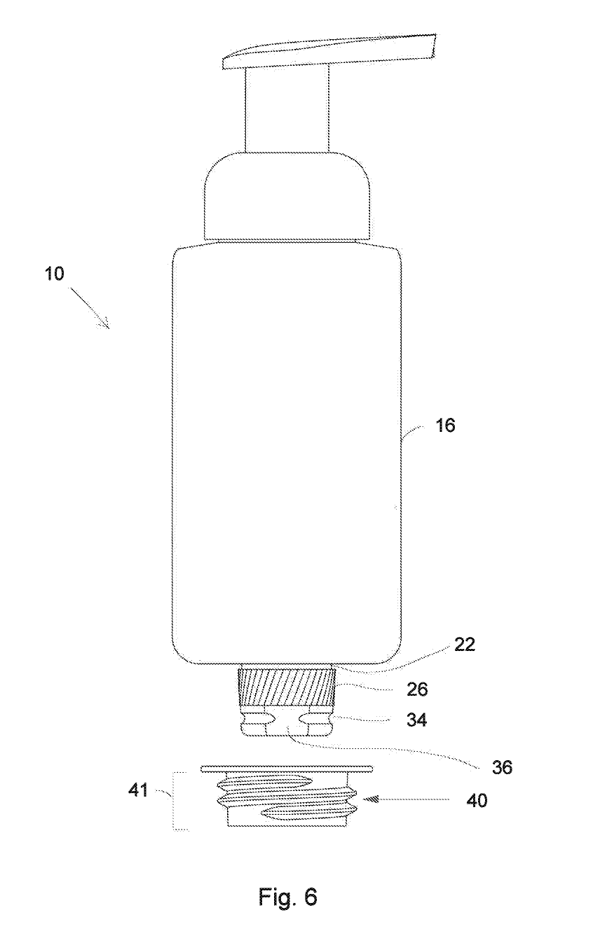

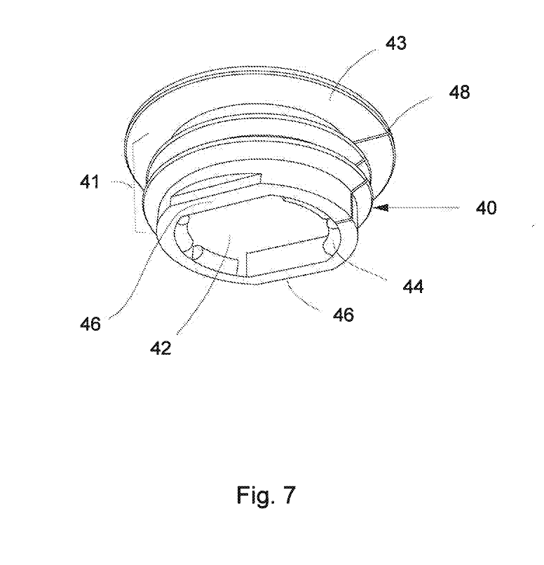

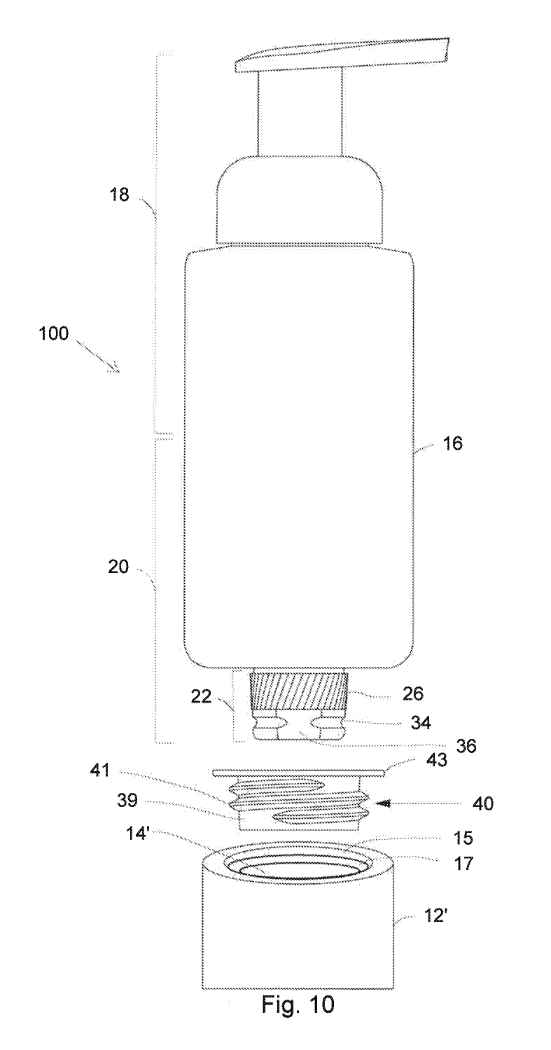

In a further embodiment, an adaptor 40 may be provided as shown in FIGS. 6-9B, wherein the adaptor 40 is configured to surround at least a portion of the projection member 22, to adapt the projection member 22 such that it can be removably fixed to a mount 12. As shown in FIGS. 6 and 7, the adaptor 40 may include a threaded portion 41 on its outer surface, configured to interact with a threaded portion of an inner surface of a mount 12 (shown, for example, in FIG. 10), in one non-limiting embodiment. The adaptor 40 may include an adaptor opening 42 for receiving the projection member 22 there within and may also include a flanged portion 43 for abutting a lower portion 20 of the container 10 when the adaptor 40 is placed around the projection member 22.

The shape and size of an inner surface of the adaptor opening 42 may be configured to correspond to the shape and size of at least a portion of the projection member 22 in a non-limiting embodiment. For example, the adaptor 40 may include one or more flattened adaptor portions 46 which correspond to and are configured to associate with the one or more flattened portions 36 of the projection member 22, such that when the adaptor 40 is placed around the projection member 22, the projection member 22 is not rotatable relative to the adaptor 40 and the adaptor 40 is not rotatable relative to the projection member 22. The adaptor 40 may also include one or more adaptor protrusions 44, as shown in FIG. 7, wherein the one or more adaptor protrusions 44 project inwardly toward the adaptor opening 42 and are configured to associate with the one or more grooves 34 of the projection member 22 of the container 10 to secure the adaptor 40 onto the projection member 22. The adaptor 40 may further include one or more slots 48, wherein the one or more slots 48 allow the adaptor 40 to open slightly, in non-limiting embodiments, to be fit onto the projection member 22 for use. The one or more slots 48 may be provided through the adaptor 40 circumference and/or through the flange portion 43 to allow the adaptor 40 to be placed over the projection projection member 22 in non-limiting embodiments. In another non-limiting embodiment, the projection member may include a threaded portion, and an inner surface other adaptor 40 may include a complementary threaded portion, and the adaptor 40 may be threadably coupled (coupled where one element has threads and another has a receiving end to accept the threads) to the projection member 22 via the threaded portions.

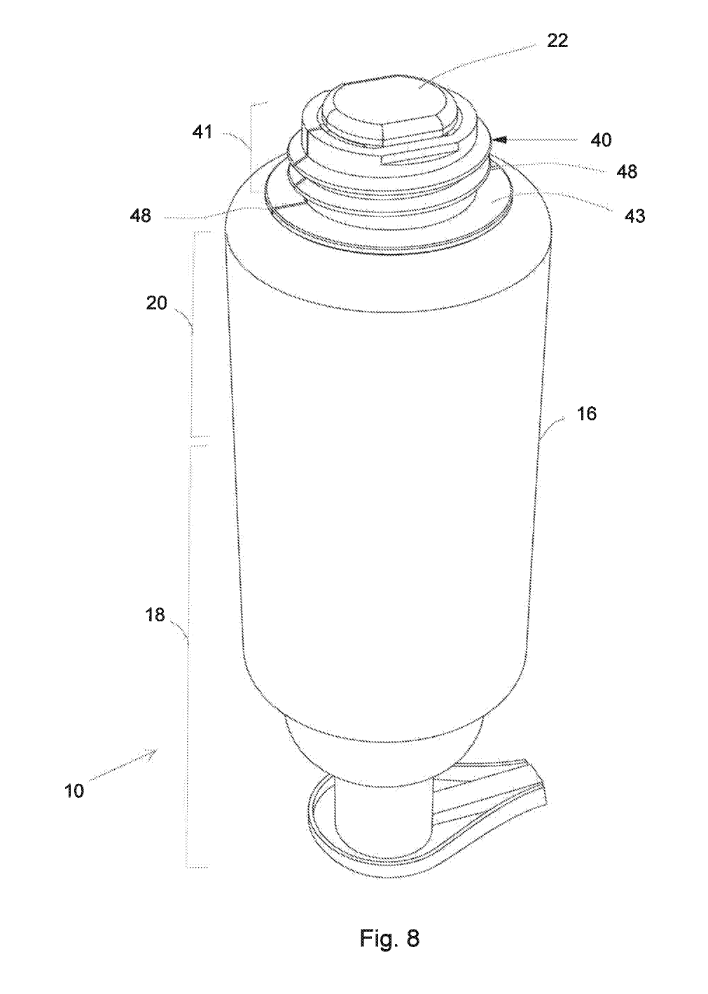

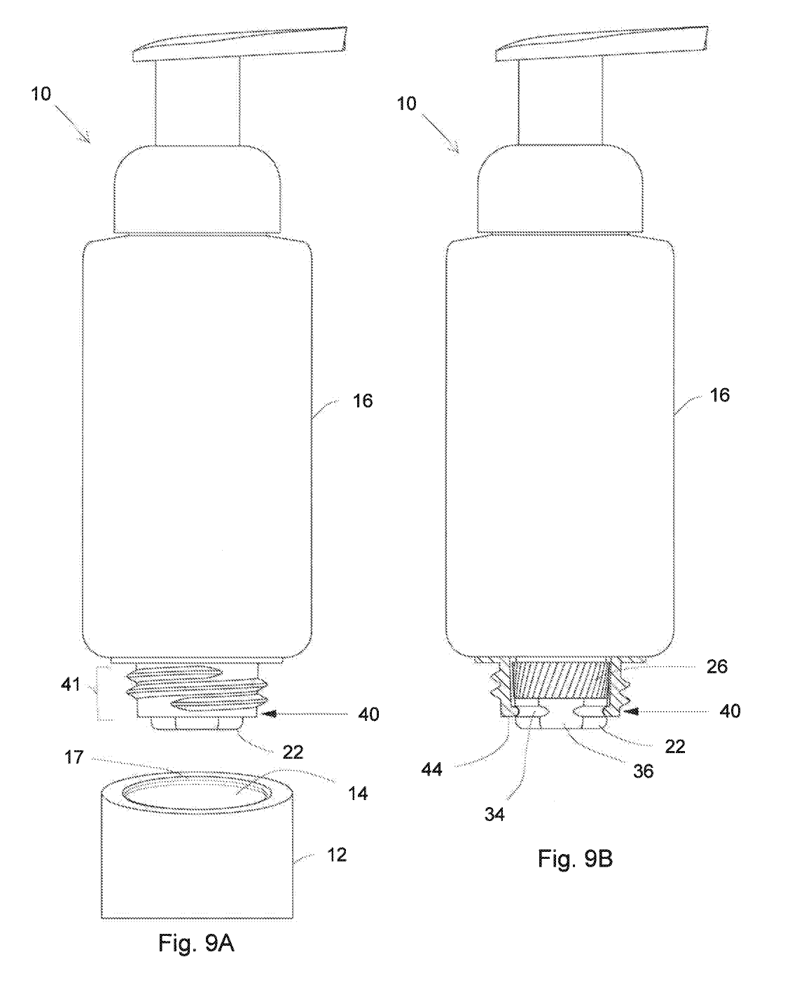

FIG. 8 shows a. perspective view of the lower portion 20 of the container 10, wherein the container is oriented such that the upper portion 18 is below the lower portion 20. The adaptor 40 is shown as secured onto the projection member 22 illustrating the flange portion 43 in contact with the lower portion 20 of the container 10. The threaded portion 41 of the adaptor 40 configured to be received within the mount 12 is also shown in FIGS. 8-9A, B.

FIG. 9A illustrates the adaptor 40 placed onto the projection member 22 of the container 10 for insertion of the projection member 22 within the opening 14 of the mount 12′. The inner surface of the mount 12′ may include a threaded portion 17 corresponding to the threaded portion 41 of the adaptor 40 so as to provide a removable engagement between the projection member 22 and the mount 12′, when the threaded portion 41 of the adaptor 40 is engaged with the threaded portion 17 of the inner surface of the mount 12′.

FIG. 9B provides a cross sectional view of the adaptor 40 provided in FIG. 9A, revealing the projection member 22 with the groove 34 and the material 26 disposed thereon. The material 26 may interact with an inner surface of the adaptor 40 when the adaptor 40 is placed onto the projection member 22. As aforementioned, the ring member 28 may be placed around the projection member 22, wherein the adaptor 40 may be placed around the projection member 22 and the ring member 28. Also shown in FIG. 9B is the engagement between the adaptor protrusion 44 and the groove 34 of the projection member 22 so as to secure the adaptor 40 onto the projection member 22. Furthermore, the material 26 may assist in preventing rotational movement between the projection member 22 and the adaptor 40, as an alternative to, or in addition to the flattened portion 36 interacting with the flattened portion (not shown) on an inner surface of the adaptor 40, in a non-limiting embodiment.

FIG. 10 includes an embodiment of a dispensing system 100 including a housing 16 for containing a fluid, such as a liquid soap in a non-limiting example. The housing 16 includes an upper housing portion 18 for delivering the liquid soap to a user and a lower housing portion 20 for associating with the mount 12′, and for securing the housing 16 there within.

Alternatively, the lower housing portion 20 may be used for association with an adaptor 40 configured to associate with the mount 12′.

The lower housing portion 20 includes a projection member 22 from the lower portion 20 of the housing 16. The projection member 22 may include a generally cylindrically shaped member, in a non-limiting embodiment, and may include a recessed portion 24 (shown in FIG. 2). In an alternative embodiment, the projection member 22 may not include the recessed portion 24. The projection member 22 may be of a shape and size configured to fit directly into an opening 14′ of the mount 12′, in one non-limiting embodiment. In another non-limiting embodiment, the projection member 22 may be of a shape and size configured to fit within an adaptor 40, wherein the adaptor is configured to fit into the opening 14′ of the mount.

The projection member 22 of the container 10 may include a cylindrically shaped member, in one non-limiting embodiment, having at least one recessed portion 24 (recessed portion shown in FIG. 2). The recessed portion 24 may include or be configured to fit within the mount opening 14′ or within an adaptor opening (not shown in FIG. 10) and is further configured to accept a material 26 while still being configured to fit within the mount opening 14′ with the material 26 attached. The material 26 may include a rubber or other similar material as known to those of skill in the art, in non-limiting embodiments. In an embodiment, the material 26 includes a slip-resistant material. The material 26 may minimize movement between the projection member 22 and the mount opening 14′ or the adaptor opening 14′, in a non-limiting embodiment, preventing or decreasing rotational movement there between. In another non-limiting embodiment, the material 26 may be formed as a ring member 28 (as shown in FIG. 4), configured to surround the at least one recessed portion 24 of the projection member 22 of the container 10. In another embodiment, as aforementioned, the projection member 22 may not include a recessed portion 24, and the material 26 for fixating the projection member 22 within the mount opening 14′ may be associated with at least a portion of the projection member 22 or may be integrated into the projection member 22 as part of the recessed portion 24.

In a non-limiting embodiment, the adaptor 40 may include a flange 43, configured to abut an upper surface of the mount and/or a lower surface 20 of the housing 16. The adaptor 40 may further include a threaded portion 41 on an outer surface 39 thereof, complementary to a threaded portion 17 on an inner surface 15 of the mount 12′, in a non-limiting example, whereby the adaptor 40 may be threadably coupled to the mount 12′ via the threaded portions 41 and 17. The adaptor 40 is configured to receive the projection member 22 within its opening (not shown in FIG. 10).

The shape and size of an inner surface of the adaptor opening may correspond to the shape and size of at least a portion of the projection member 22 in a non-limiting embodiment, such that the projection member 22 may be received within the adaptor opening.

For example, the adaptor 40 may include one or more flattened adaptor portions on an inner surface of the adaptor 40 which correspond to and are configured to associate with one or more flattened portions 36 of the projection member 22, to restrict or prevent rotational movement between the adaptor 40 and the projection member 22 when the projection member is received within the adaptor opening. In one non-limiting embodiment, the projection member 22 may not include a recessed portion 24 or a material 26 to prevent rotation, and the flattened portion(s) 36 may alone serve to prevent rotational movement between the projection member 22 and. the adaptor 40. In another non-limiting embodiment, the mount 12′ may include a flattened portion at least on its inner surface, configured to associate with a flattened portion 36 on the projection member, so as to prevent rotational movement of the projection member relative to the mount 12′ in an embodiment.

As mentioned above in regard to FIG. 7, the adaptor 40 may also include one or more adaptor protrusions 44 (see FIG. 7), wherein the one or more adaptor protrusions 44 project inwardly toward the adaptor opening 42 and are configured to associate with the one or more grooves 34 of the projection member 22 of the container 10 to secure the adaptor 40 onto the projection member 22. The adaptor 40 may include one or more slots 48, in a non-limiting embodiment, wherein the one or more slots 48 allow the adaptor 40 to fit over the projection member 22. The one or more slots 48 may be provided through the adaptor 40 circumference and/or through the flange portion 43 to allow the adaptor 40 to be placed over the projection member 22, for example.

Various securing means are provided and described herein for attaching or securing the container 10 to a mount 12 such as threaded portions, ring members and/or materials having ribbed portions, certain structural features of the projection member and the adaptor and/or the mount described herein such as the grooves and protrusions and the flattened portions of the structures described herein. However, other means for securing are also contemplated herein including, but not limited to, channels, pins, ball-detents, locks, flanges, couplers, indentations, flexible arms, resilient arms or any other appropriate securing means known to those of ordinary skill in the art for securing the container to the mount, the container to the adaptor, and/or the adaptor to the mount as described herein.

Thus, as disclosed above, the dispensing container may include a projection member having one or more grooves, one or more flattened portions and a recessed portion in non-limiting embodiments, configured for engaging with a. mount or an adaptor having protrusions and one or more corresponding flattened portions. Embodiments of the dispensing container as disclosed herein are not rotatable within the mount once placed within the mount. A ring member may be placed around or a material may be disposed on at least a portion of the projection member for easibility of insertion of the projection member within the mount in one non-limiting embodiment.

In one non-limiting embodiment, a dispensing container having a housing for containing a fluid is provided. The housing includes an upper housing portion and a lower housing portion, the upper housing portion configured to delivering the fluid from the container. A projection member is provided, extending from the lower housing portion, wherein the projection member is configured to fit within a mount such that the housing may be secured in a generally vertical configuration extending upward from the mount when positioned there within. A material is disposed on the projection member, wherein the material is configured to be disposed between the projection member and at least a portion of the mount when the projection member is received within the mount.

In another non-limiting embodiment, a dispensing container configured to be received within a mount having a mount opening for receiving the dispensing container is provided herein. The dispensing container includes a housing for containing a fluid, the housing including an upper housing portion and a lower housing portion, the upper housing portion for delivering the fluid from the container. A projection member extends from. the lower housing portion, wherein the projection member includes a recessed portion inscribed in at least a portion of a circumferential surface of the projection member, and at least one flattened portion on the circumferential surface. The at least one flattened portion of the projection member is configured to associate with at least one flattened portion of an inner surface of the mount opening to substantially prevent rotation of the container relative to the mount. A least one groove may be inscribed into a portion of the circumferential surface of the projection member, wherein the at least one groove comprises a first end and a second end, wherein said first and second ends terminate at the at least one flattened portion of the projection member, wherein the projection member is configured to be removably engageable within the mount opening.

In still a further non-limiting embodiment, the dispensing system may include a housing for containing a fluid, the housing having an upper housing portion and a lower housing portion, the upper housing portion being configured for delivering the fluid from the container. A projection member may be configured. to extend from the lower housing portion, wherein the projection member has a recessed portion inscribed in at least a portion of the circumferential surface of the projection member, and a material may be disposed on said projection member, wherein the material may include a slip resistant material configured to minimize movement. The system may further include a mount having an outer surface, an inner surface, and a mount opening The mount opening may be of a shape and dimension configured to receive the projection member such that the housing may be secured in a generally vertical configuration extending upward from the mount, and the material may be disposed between the projection member and the inner surface of the mount to prevent rotational movement between the projection member and the mount.

Unless otherwise defined, all terms (including technical and scientific terms) used herein have the same meaning as commonly understood by one of ordinary skill in the art to which embodiments of the invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

While various disclosed embodiments have been described above, it should be understood that they have been presented by way of example only, and not limitation. Numerous changes, omissions and/or additions to the subject matter disclosed herein can be made in accordance with the embodiments disclosed herein without departing from the spirit or scope of the embodiments. Also, equivalents may be substituted for elements thereof without departing from the spirit and scope of the embodiments. In addition, while a particular feature may have been disclosed with respect to only one of several implementations, such feature may be combined with one or more other features of the other implementations as may be desired and advantageous for any given or particular application. Furthermore, many modifications may be made to adapt a particular situation or material to the teachings of the embodiments without departing from the scope thereof.

Therefore, the breadth and scope of the subject matter provided herein should not be limited by any of the above explicitly described embodiments. Rather, the scope of the embodiments should be defined in accordance with the following claims and their equivalents.

What is claimed is:

1. A dispensing container, comprising:
a housing for containing a fluid, said housing comprising an upper housing portion and a lower housing portion, said upper housing portion for delivering the fluid from the container;
a projection member, having a circumferential surface, extending from the lower housing portion, wherein, said projection member fits within a mount such that the housing can be secured in a generally vertical configuration extending upward from the mount when positioned there within; and
a material disposed on said projection member to minimize movement of the housing when secured.

2. The dispensing container according to claim 1, further comprising the mount.

3. The dispensing container according to claim 1, wherein the projection member comprises a recessed portion within at least a portion of the circumferential surface of the projection member.

4. The dispensing container according to claim 3, wherein the material is disposed within at least a portion of the recessed portion.

5. The dispensing container according to claim 1, wherein the material comprises a slip resistant material provided to prevent a rotational movement of the projection member relative to the mount when the projection member is placed there within.

6. The dispensing container according to claim 1, further comprising an adaptor, comprising an upper portion, a lower portion, an outer surface, an inner surface and an adaptor opening adjacent to the inner surface to receive the projection member within the adaptor opening, the lower portion of the adaptor fits within the mount to secure the dispensing container to the mount.

7. The dispensing container according to claim 2, wherein said material is disposed between the projection member and at least a portion of the mount when the projection member is received within the mount.

8. A dispensing container to be received within a mount having a mount opening for receiving the dispensing container, said dispensing container comprising:
a housing for containing a fluid, said housing comprising an upper housing portion and a lower housing portion, said upper housing portion for delivering the fluid from the container;
a projection member extending from the lower housing portion, wherein said projection. member comprises a recessed portion within at least a portion of a circumferential surface of the projection member, and at least one flattened portion on the circumferential surface, the at least one flattened portion of the projection member associated with at least one flattened portion of an inner surface of the mount opening to substantially prevent rotation of the container relative to the mount; and
at least one groove within a portion of the circumferential surface of the projection member, wherein the at least one groove comprises a first end and a second end, wherein said first and second ends terminate at the at least one flattened portion of the projection member, and wherein the projection member is removably engageable within the mount opening.

9. The dispensing container of claim 8, further comprising a material disposed on a portion of the circumferential surface of the projection member at the recessed portion, wherein the material is disposed between the projection member and the inner surface of the mount opening when the projection member is received within the mount opening.

10. The dispensing container of claim 8, further comprising a ring member to surround the projection member adjacent to the recessed portion, wherein the ring member contacts the inner surface of the mount opening when the projection member is placed within the opening.

11. The dispensing container of claim 8, further comprising an adaptor having an outer surface, an inner surface, and an adaptor opening, the adaptor opening receives the projection member, the adaptor opening comprising at least one flattened adaptor portion, the flattened adaptor portion contacts the at least one flattened portion of the projection member, wherein the adaptor further comprises at least one protrusion projecting inward from the inner surface of the adaptor toward the adaptor opening, and wherein the at least one protrusion engages with the at least one groove of the projection member, the adaptor is placed within the opening of the mount.

12. The dispensing container of claim 8, wherein the adaptor further comprises a threaded portion on an outer surface thereof, wherein the threaded portion rotatably engages with a complementary threaded portion on a portion of an inner surface of the mount opening.

13. A dispensing system, comprising:
a housing for containing a fluid, the housing comprising an upper housing portion and a lower housing portion, the upper housing portion for delivering the fluid from the container;
a projection member extending from the lower housing portion, wherein the projection member comprises a recessed portion within at least a portion of the circumferential surface of the projection member;
a material disposed on said projection member, wherein the material comprises a slip resistant material to minimize movement; and
a mount comprising an outer surface, an inner surface, and a mount opening, said mount opening having a shape and dimension to receive the projection member such that the housing can be secured in a generally vertical configuration extending upward from the mount, and the material is disposed between the projection member and the inner surface of the mount to prevent rotational movement of the housing.

14. The dispensing system of claim 13, further comprising an adaptor comprising an upper portion, a lower portion, an outer surface, an inner surface, and an adaptor opening adjacent to the inner surface, the adaptor to receive the projection member within the adaptor opening, the lower portion of the adaptor to fit within the mount to secure the housing to the mount.

15. The dispensing system of claim 14, wherein the adaptor further comprises a threaded portion on an outer surface thereof, wherein the threaded portion rotatably engages with a complementary threaded portion on a portion of the inner surface of the mount.
